(19) United States
(12) Patent Application Publication
(10) Pub. No.: US 2006/0198626 A1
(43) Pub. Date: Sep. 7, 2006

(54) Imaging device

(75) Inventors: Tadashi Nakamura, Hoi-gun (JP); Hidehito Terazawa, Obu-city (JP); Kiyokazu Yoshida, Kiyosu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION

(21) Appl. No.: 11/362,721

(22) Filed: Feb. 28, 2006

(30) Foreign Application Priority Data
Mar. 1, 2005 (JP) 2005-56645
Mar. 22, 2005 (JP) 2005-82259

(51) Int. Cl. G03B 7/08; G03B 17/00

(52) U.S. Cl. 396/234; 396/427

(57) ABSTRACT

An imaging device for use in a vehicle includes an imaging unit having a lens for imaging a state of affairs and an exposure control unit for controlling exposure of the imaging by the imaging unit. The imaging unit images substantially a whole perspective in the vehicle including at least portions of windows on lateral sides of the vehicle. The exposure control unit uses brightness of an area in a predetermined frame of an image taken by the imaging unit for determining the exposure of the imaging, and the area in the predetermined frame in the image is set to be positioned at a proximity of a target area of the imaging.

### CROSS REFERENCE TO RELATED APPLICATION

This application is based on and claims the benefit of priority of Japanese Patent Application No. 2005-56645 filed on Mar. 1, 2005, and Japanese Patent Application No. 2005-82259 filed on Mar. 22, 2005, the disclosure of which are incorporated herein by reference.

### FIELD OF THE INVENTION

The present invention generally relates to an imaging device for capturing an image in a vehicle.

### BACKGROUND OF THE INVENTION

An imaging device in the vehicle is used for image collection in the vehicle. That is, the imaging device captures the image for use, for example, as a piece of evidence of a deed, a state of affairs or the like in the vehicle. In pursuit of the image collection in the vehicle, a plurality of the imaging devices at plural positions in the vehicle are used as disclosed in Japanese Patent Document JP-A-2004-268610. The plural imaging device for the coverage of an entire area of the inside of the vehicle can be replaced by a single imaging device being equipped with, for example, a fish-eye lens. In this case, the imaging device may be positioned at an arbitrary position on an indoor surface of the roof, that is, for example, around a center portion, or a front area of the roof, for capturing the image with the lens pointing toward the inside of the vehicle as shown in FIG. 8. However, the direct sunlight can easily be projected on the lens of the imaging device when the device is positioned at the center portion of the roof. In addition, the imaging device uses a part of the image as an “exposure frame,” or an exposure determination area, for determining the exposure to be an appropriate duration of time. However, the brightness of the image in the exposure frame may sometimes become extremely high because of direct sunlight shone on the interior of the vehicle. That is, the brightness of the other part of the image becomes relatively low for having a clear image of an object in the vehicle. As a result, the imaging device fails to capture a clear image for, for example, use as the piece of evidence.

### SUMMARY OF THE INVENTION

In view of the above-described and other problems, the present invention provides an imaging device that takes a clear image of an object in an inside and a vicinity of a vehicle.

The imaging device of the present invention includes an imaging unit having a lens for imaging a state of affairs as a perspective view, and an exposure control unit for controlling exposure of the imaging by the imaging unit. The imaging unit images substantially a whole perspective in the vehicle including at least portions of windows on lateral sides of the vehicle, and the exposure control unit in the imaging device uses brightness of an area in a predetermined frame of an image taken by the imaging unit for determining the exposure of the imaging, and the area in the predetermined frame of the image partially is set to be positioned at a proximity of a target area of the imaging.

In this manner, the imaging unit of the present invention takes a picture of the object in the vehicle by controlling the exposure based on the brightness of an area that is not lit by direct sunlight from outside of the vehicle. As a result, the image of the object in the vehicle is formed with clarity because the exposure of the imaging is suitably controlled for the brightness of the target object.

The imaging device of the present invention is further characterized by the following aspects. That is, the brightness used to determine the exposure is taken from the area of the image that includes an occupant in a front seat of the vehicle. In this manner, the exposure of the imaging is suitably determined for imaging, for example, a face of the occupant.

Further, the imaging unit is positioned at a proximity of a front portion of a roof inside the vehicle. In this manner, a whole perspective in the vehicle including windows on the right/left sides of the vehicle can substantially be captured in the image taken by the imaging unit.

Furthermore, the brightness used to determine the exposure is taken from the area in the predetermined frame including a center portion of a rear seat. For example, the exposure of the imaging is determined for the area of the image that partially includes the face of the occupant of the front seat and the rear seat which is scarcely lit by the direct sunlight.

Furthermore, the brightness used to determine the exposure is taken from the area of the image of windows on both sides of the vehicle. For example, the exposure of the imaging is determined based on the area of the image of the windows. In this manner, overexposure of the imaging is prevented by taking incoming sunlight from the windows into consideration.

Furthermore, the exposure control unit controls exposure of the imaging by weighting areas in the image. That is, the brightness in an area inside of an exposure determination frame is weighted differently from the brightness in an area outside thereof. Weighting for the brightness in the exposure determination frame is greater than weighting for the brightness outside of the exposure determination frame. In this manner, the brightness in the exposure determination frame is prioritized than the brightness outside of the frame in the course of the imaging.

Furthermore, the imaging device of the present invention is positioned at a proximity of a front end of a roof in the vehicle. In this manner, the imaging device is suitably integrated into an interior roof of the vehicle, and is capable of imaging the perspective view in the vehicle, including at least portions of the windows on both sides. The positioning of the imaging device is beneficial for preventing the direct sunlight to be projected on the lens of the imaging device, and is also beneficial for avoiding interference with a sunroof.

### BRIEF DESCRIPTION OF THE DRAWINGS

Other objects, features and advantages of the present invention will become more apparent from the following detailed description made with reference to the accompanying drawings, in which:

FIG. 1 shows an illustration of an imaging device positioned in a vehicle in an embodiment of the present invention;

FIG. 2A shows a side view of a position of the imaging device;

FIG. 2B shows a top view of the position of the imaging device; FIG. 2C shows a rear view of the position of the imaging device;

FIG. 3 shows an illustration of the position of the imaging device relative to windows on a side face of the vehicle;

FIG. 4 shows an illustration of an image captured by the imaging device;

FIG. 5 shows a schematic structure of the imaging device of the present invention;

FIG. 6A shows an illustration of the image with an exposure frame used in a conventional imaging device;

FIG. 6B shows an illustration of the image with the exposure frame used in the embodiment of the present invention;

FIG. 6C shows an illustration of the image with the exposure frame used in the modified embodiment of the present invention;

FIG. 7 shows a comparison table of parameter settings for the imaging; and

FIG. 8 shows an illustration of the imaging device positioned at a center of the roof.

### DETAILED DESCRIPTION OF THE PREFERRED EMBODIMENTS

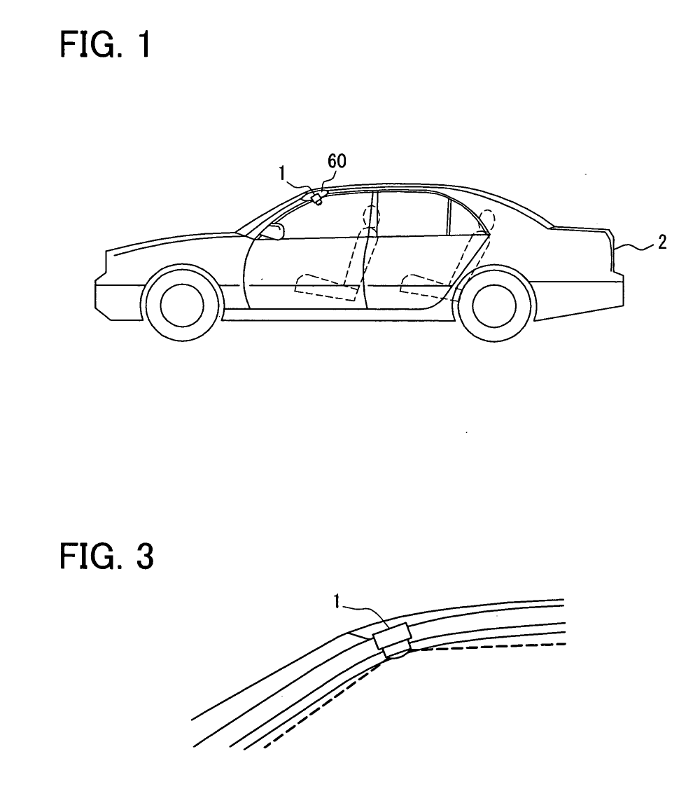

Embodiments of the present invention are described with reference to the drawings. An imaging device 1 of the present invention is illustrated as a part of a system in FIG. 1. That is, the imaging device 1 of the present invention is intended for use, for example in this case, in a vehicle security system together with a lighting device 60. The imaging device 1 and the lighting device 60 are disposed at a front end of an interior roof of a vehicle 2 and, is controlled by a control device (not shown in the figure) for cooperatively capturing an image of a state of affairs, e.g., an intrusion into the vehicle 2 or a similar situation.

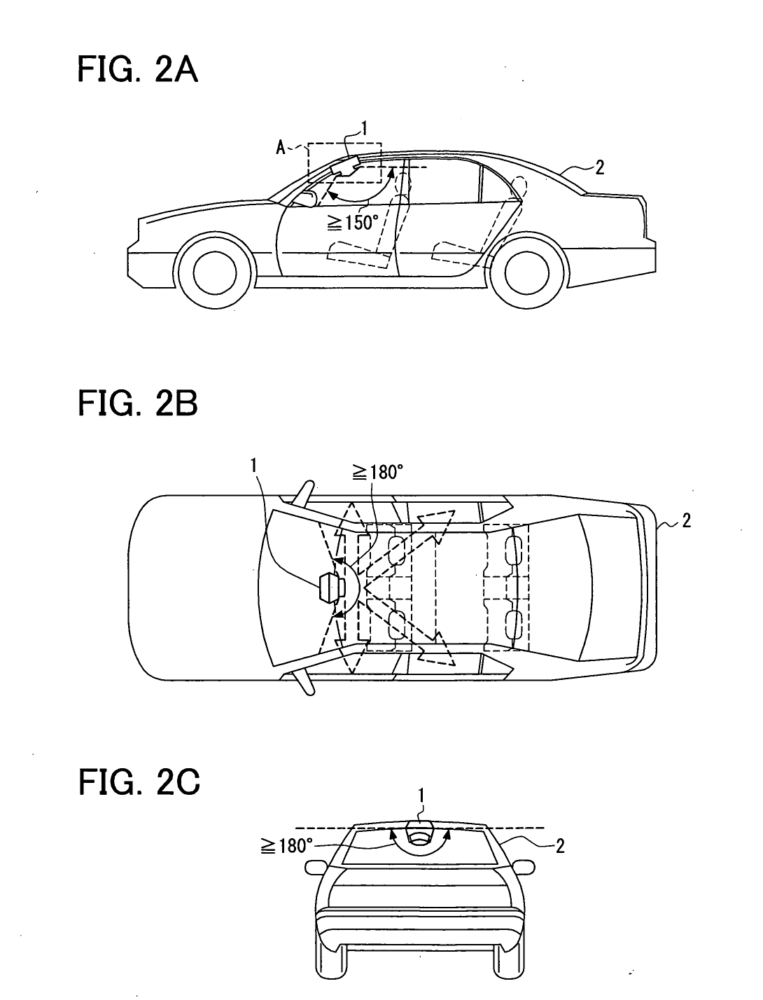

FIGS. 2A to 2C show illustration of a top view, a side view and a rear view of the imaging device 1 positioned at the front end of the interior roof. The lens 11 of the imaging device 1 is a fish-eye lens that is capable of capturing an image in a lateral field angle of 180 degrees or more and a vertical field angle of 150 degrees or more for including portions of side windows of the vehicle 2 in the perspective view. In this manner, the position and existence of the imaging device 1 is scarcely recognized from outside of the vehicle 1. Further, interference between the imaging device 1 and a sunroof is prevented by positioning the imaging device at or around the front end of the roof.

FIG. 3 shows an illustration (an expanded view of a frame A in FIG. 2A) of the position of the imaging device 1 relative to the side window of the vehicle 2. That is, the imaging device 1 is positioned above a level of an upper end of the side window. In this manner, the imaging device 1 is effectively protected from an effect of direct sunlight projected into the vehicle 2 through the side windows.

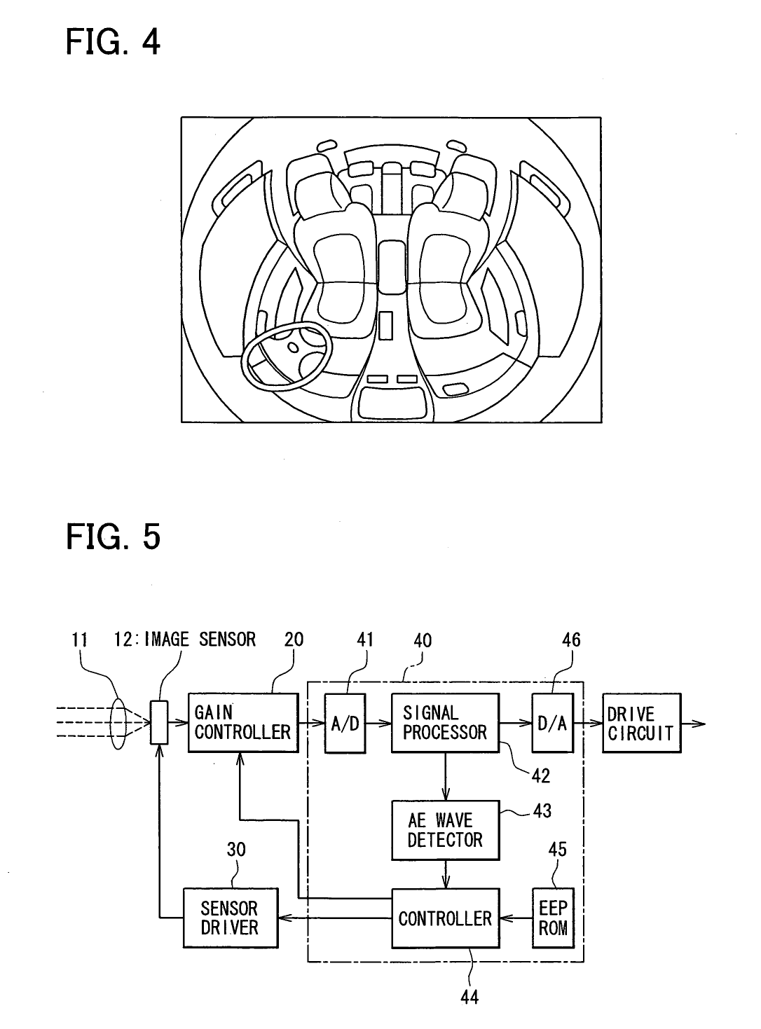

FIG. 4 shows an illustration of the image captured by the imaging device 1. In the present embodiment, the imaging device 1 is pointing in a direction tilted from a vertical line toward a rear end of the vehicle 2 for excluding a front windshield from the image. That is, the image taken by the imaging device 1 includes side windows, a rear window, an entire space in the vehicle 2 as well as interior surfaces of doors, seats, a dash board and the like.

The direction of the imaging device 1 is determined based on the following consideration. That is, the imaging device 1 is susceptible to the direct sunlight when the lens 11 of the device 1 is directed vertically downward to include the front windshield in the image. The image taken by the imaging device 1 deteriorates when the direct sunlight is projected on the lens 11 of the imaging device 1.

The other point in the consideration is that a theft of a vehicle seldom takes place by braking the front windshield because of the strength of the glass used for the front windshield. Further, an image of a thief who is operating the vehicle or removing parts from an instrument panel can be captured by including at least an area close to front seats, i.e., a driver's seat and a passenger seat.

FIG. 5 shows a schematic illustration of the imaging device 1 of the present invention. The imaging device 1 includes a lens 11, an image sensor 12, a gain controller 20, a sensor driver 30, a signal control circuit 40 having an A/D converter 41, a signal processor 42, an A/E wave detector 43, a controller 44, an EEPROM 45 and a D/A converter 46. The imaging device 1 uses the image sensor 12 for imaging a perspective view in the vehicle 2 optically captured with the lens 11. The image sensor 12 outputs an analog signal for transferring an image of the perspective view with an attribute of brightness of each pixel in the image. The sensor driver 30 controls shutter speed and aperture of the image sensor 12 for optimum adjustment of exposure of the image taken by the imaging device 1.

The gain controller 20 automatically amplifies the analog signal from the image sensor 12 based on an amplitude calculated in the signal control circuit 40. The control circuit 40 also controls the sensor driver 30 for capturing the image with the optimum exposure.

The A/D converter 41 converts the analog signal from the gain controller 20 to a digital signal.

The signal processor 42 performs brightness calculation for determining brightness of each pixel in the image, and brightness signal of each pixel accompanied by horizontal/vertical synchronization signals is sent from the signal processor 42 to the A/E wave detector 43. The signal processor 42 also performs an outline correction process for extracting edges in the image, a color correction process for distinctively recognizing colors in the image, and the brightness signal after correction is sent to the D/A converter 46. The D/A converter 46 converts the digital signal from the signal processor 42 to the analog signal before sending the analog signal to a drive circuit.

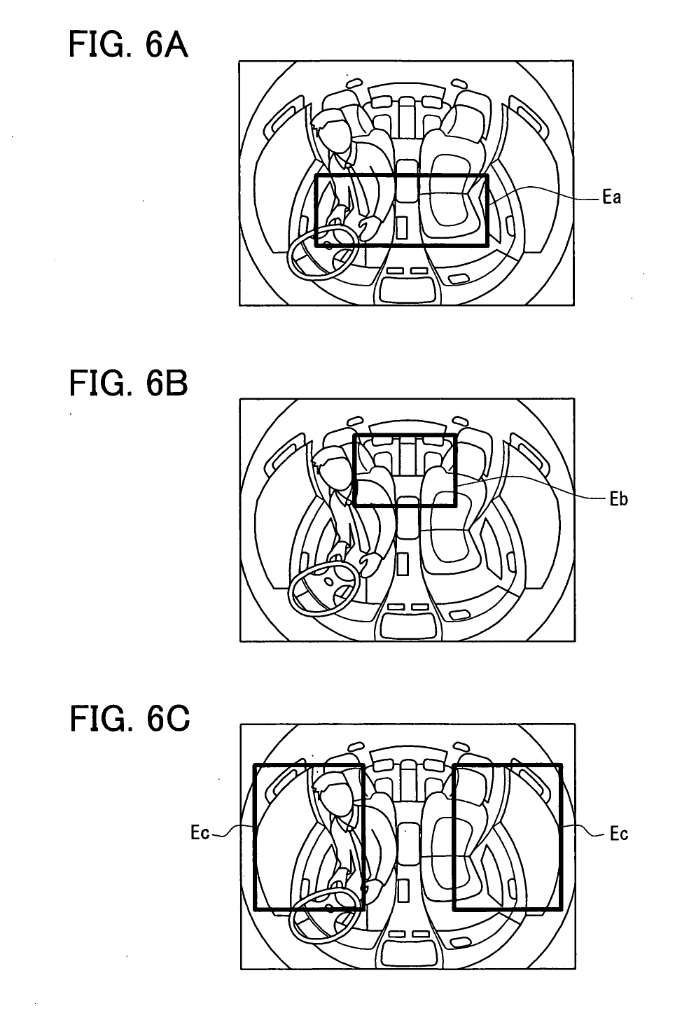

The A/E wave detector 43 detects brightness of each pixel in the image. The A/E wave detector 43 sets an automatic exposure frame in the image as a reference portion. FIG. 6A illustrates a position of the automatic exposure frame Ea in the image when the imaging device 1 is made by using a reverse travel camera, and FIG. 6B illustrates a position of the automatic exposure frame Eb in the image of the imaging device 1 of the present invention.

The exposure frame Ea of the imaging device 1 is positioned in a lower portion in the image when the imaging device 1 is a conversion from the reverse travel camera, because the reverse travel camera is originally intended for capturing image of a road surface. That is, the exposure of the image is controlled based on the brightness of the exposure frame that is set to include the road surface. However, the lower portion in the image always includes a front seat area when the imaging device 1 is used for capturing the image in the vehicle 2. As a result, the image taken by the converted imaging device 1 based on the exposure of the front seat area often fails to form a clear image, because the brightness of the front seat area under the direct sunlight becomes sometimes too high to be used as the reference portion.

On the contrary, the exposure frame Eb of the imaging device 1 of the present invention is positioned in an upper portion in the image as shown in FIG. 6B. More practically, the exposure frame Eb is set to include a center portion of the rear seat. In this manner, the exposure frame Eb includes a portion of the image that scarcely comes under the direct sunlight. The exposure frame Eb positioned in this manner is also beneficial because the frame Eb is closely positioned around a face of an occupant of the front seat.

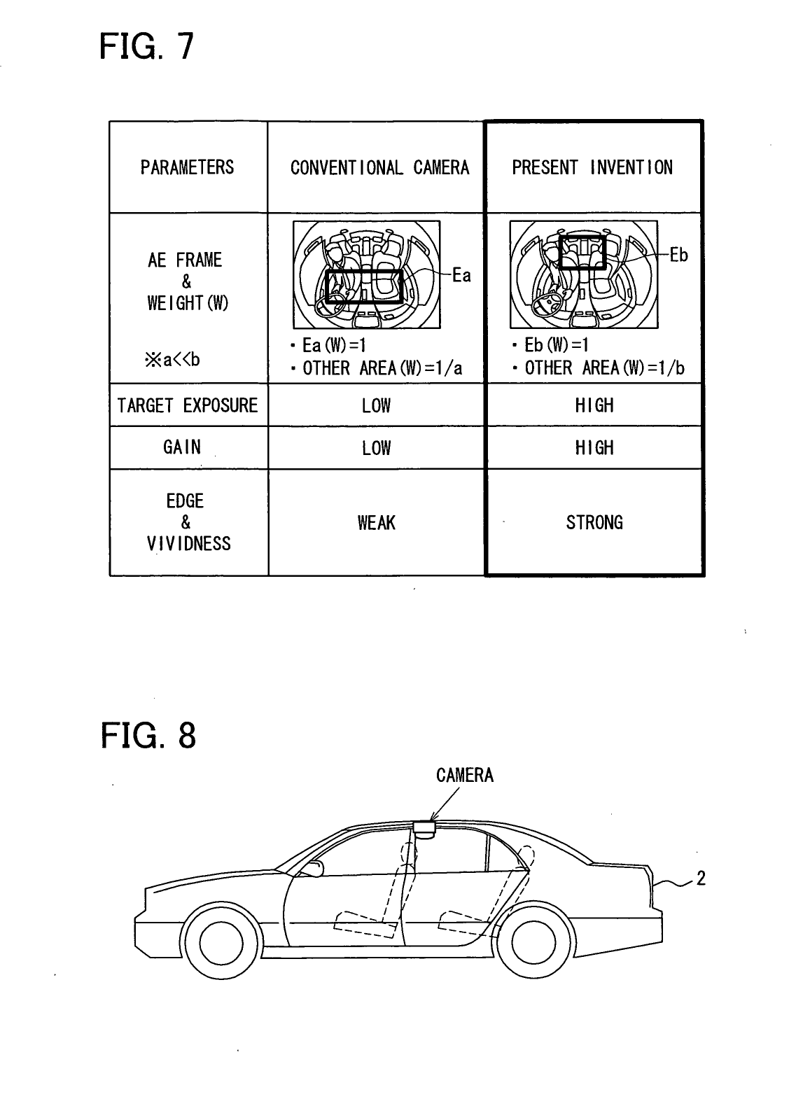

FIG. 7 shows a comparison table of parameter settings for the imaging. That is, the A/E wave detector 43 sets a heavier weight for the brightness of the pixels in the frame Eb than the pixels outside of the frame Eb when it detects the brightness. In the present embodiment, the weight (W) for the pixels in the frame Eb is set to 1, and the weight for other pixels is set to 1/b. In this manner, the exposure of the image is controlled by prioritizing the brightness in the frame Eb.

The constant b used in the weighting is set to be greater than the constant a used in the reverse travel camera. That is, the weighting for the pixels in the frame Eb is heavier than the reverse travel camera.

The other parameters used for the imaging is determined in the following manner due to a generally dim image in the frame Eb. That is, for example, a target exposure value and a gain amplitude are set to be higher than the reverse camera, and parameters for edge reinforcement and for vividness of the color are also set to be greater than the settings in the reverse camera.

The controller 44 calculates the target exposure value based on the brightness detected by the A/E wave detector 43 and the settings stored in the EEPROM 45. The controller 44 sends an exposure signal to the sensor driver 30 after the calculation. The controller 44 also calculates the amplitude of the analog signal to output an amplitude signal to the gain controller 20.

In this manner, the imaging device 1 of the present invention suitably forms a clear image of the perspective view in the vehicle 2 based on the brightness in the exposure frame Eb that is set to include the center portion of the rear seat.

Although the present invention has been fully described in connection with the preferred embodiment thereof with reference to the accompanying drawings, it is to be noted that various changes and modifications will become apparent to those skilled in the art.

For example, the exposure frame Eb may be set to include a portion of windows on both sides of the vehicle 2. That is, the exposure frames Ec may be positioned on a window area in the image as shown in FIG. 6C. In this manner, the exposure of the image captured by the imaging device 1 can be suitably controlled because the exposure frame Ec allows the imaging device 1 to accurately recognize conditions of the direct sunlight projected into the vehicle 2.

Such changes and modifications are to be understood as being within the scope of the present invention as defined by the appended claims.

What is claimed is:

1. An imaging device for use in a vehicle comprising:
an imaging unit having a lens for imaging a state of affairs; and
an exposure control unit for controlling exposure of the imaging by the imaging unit,
wherein the imaging unit images substantially a whole perspective in the vehicle including at least portions of windows on lateral sides of the vehicle,
the exposure control unit uses brightness of an area in a predetermined frame of an image taken by the imaging unit for determining the exposure of the imaging, and
the area in the predetermined frame in the image is set to be positioned at a proximity of a target area of the imaging.

2. The imaging device according to claim 1,
wherein a portion of the target area of the imaging includes a position of an occupant in a front seat of the vehicle.

3. The imaging device according to claim 2,
wherein the imaging unit is positioned at a proximity of a front portion of a roof in the vehicle.

4. The imaging device according to claim 3,
wherein the area of the predetermined frame includes at least a proximity of a center portion of a rear seat of the vehicle.

5. The imaging device according to claim 3,
wherein the predetermined frame includes a portion of windows on lateral sides of the vehicle.

6. The imaging device according to claim 4,
wherein the exposure control unit controls exposure of the imaging by weighting areas in the image, and
weight for the area in the predetermined frame is set to be greater than weight for the area outside of the predetermined frame.

7. The imaging device according to claim 1,
wherein the lens of the imaging unit is positioned above a level of an upper end of the window disposed on a lateral side of the vehicle.
